(19) United States
(12) Patent Application Publication
(10) Pub. No.: US 2021/0336863 A1
(43) Pub. Date: Oct. 28, 2021

(54) A METHOD AND DEVICE FOR MONITORING HOST COMPUTERS

(71) Applicant: WANGSU SCIENCE & TECHNOLOGY CO., LTD., Shanghai (CN)

(72) Inventors: Qingrong LI, Shanghai (CN); Chen FU, Shanghai (CN)

(21) Appl. No.: 16/473,526

(22) PCT Filed: Sep. 26, 2018
(86) PCT No.: PCT/CN2018/107478

§ 371 Date: Jun. 25, 2019

(30) Foreign Application Priority Data
Aug. 15, 2018 (CN) 201810930501.8

(51) Int. Cl. H04L 12/26

(52) U.S. Cl. CPC H04L 43/045; H04L 43/0876; H04L 43/0817; H04L 43/065

(57) ABSTRACT

A method for monitoring host computers includes: providing a preset script that, when executed, implements the following steps including: acquiring node information of a target node and host computer information of a target host computer in the target node; calling a host computer template that matches the target host computer, and creating an instance of the target host computer in a monitoring system according to the host computer information and the host computer template; adding the created instance to a node tree corresponding to the node information; determining a to-be-monitored port of the created instance in the node tree based on the host computer information, calling a graph template that matches the port, and creating a port graph corresponding to the port for the created instance; and collecting real-time data of the port and drawing the collected real-time data into the port graph.

### FIELD OF DISCLOSURE

The present disclosure generally relates to the field of Internet technology and, more particularly, relates to a method and device for monitoring host computers.

### BACKGROUND

Currently, a Cacti system may be used to monitor the load and traffic of each host computer in a CDN (Content Delivery Network). The Cacti system may map the load and traffic data of each port in each host computer into a port graph, to allow an administrator to easily monitor real-time data of a host computer.

In the existing technologies, when an administrator uses the Cacti system, the administrator usually needs to manually add a host computer to the system, add a host computer to a node tree, configure the port graphs for the host computers, name the host computers and the port graphs, and combine the port graphs, etc., in the system. The way of manually creating port graphs for each host computer clearly is not able to meet the needs for an increasing number of host computers. Therefore, there is a need for a more efficient method for monitoring host computers.

### BRIEF SUMMARY OF THE DISCLOSURE

The objective of the present disclosure is to provide a method and device for monitoring host computers, which may improve monitoring efficiency.

To achieve the above objective, in one aspect, the present disclosure provides a method for monitoring host computers, which includes providing a preset script that, when executed, implements the following steps: acquiring node information of a target node and host computer information of a target host computer in the target node; calling a host computer template that matches the target host computer, and creating an instance of the target host computer in a monitoring system according to the host computer information and the host computer template; adding the created instance to a node tree corresponding to the node information; determining a to-be-monitored port of the created instance in the node tree based on the host computer information, calling a graph template that matches the port, and creating a port graph corresponding to the port for the created instance; and collecting real-time data of the port and drawing the collected real-time data into the port graph.

To achieve the above objective, in another aspect, the present disclosure further provides a device for monitoring host computers, where the device includes a system for monitoring host computers, and the system is configured to implement the foregoing method.

To achieve the above objective, in another aspect, the present disclosure further provides a device for monitoring host computers. The device includes a memory and a processor, where the memory is used to store a preset script that, when executed by the processor, implement the foregoing method.

As can be seen from the above, in the technical solutions provided by the present disclosure, each step involved in the process of monitoring host computers may be written into a preset script. The preset script, when executed, may then implement the process of monitoring a host computer. Specifically, when the preset script is executed, the Cacti system may obtain the node information of a target node and the host computer information of a target host computer in the target node by accessing a resource server in the CDN. An instance of the target host computer may be then created through matching a template corresponding to the host computer. After the instance of the target host computer is created, the created instance may be added to a node tree corresponding to the target host computer. In order to monitor the status of each port of the target host computer by way of a graph, to-be-monitored ports for the created instance may be determined, and a port graph may be created for each port by calling a graph template that matches the port. The port graph may be configured to receive real-time data of the port, and display the collected real-time data by way of a graph, to allow an administrator to monitor the target host computer. As can be seen from the above, through an approach of pre-writing each step to the preset script, the port graphs may be created automatically and in batch for a large number of host computers, which solves the problem of inefficiency caused by human manipulation while also avoiding errors caused by human manipulation.

### BRIEF DESCRIPTION OF THE DRAWINGS

To make the technical solutions in the embodiments of the present disclosure clearer, a brief introduction of the accompanying drawings consistent with descriptions of the embodiments will be provided hereinafter. It is to be understood that the following described drawings are merely some embodiments of the present disclosure. Based on the accompanying drawings and without creative efforts, persons of ordinary skill in the art may derive other drawings.

FIG. 1 is a flowchart of a method for monitoring host computers according to some embodiments of the present disclosure;

FIG. 2 is a processing flow of a method for monitoring host computers according to some embodiments of the present disclosure; and

FIG. 3 is a schematic structural diagram of a device for monitoring host computers according to some embodiments of the present disclosure.

### DETAILED DESCRIPTION

To make the objective, technical solutions, and advantages of the present disclosure clearer, the implementations of the present disclosure will be made in detail hereinafter with reference to the accompanying drawings.

The present disclosure provides a method for monitoring host computers. Each processing step involved in the method may be programmed into a preset script. Accordingly, by executing the preset script, each step of the method may be automatically implemented. The preset script may be programmed using a specified programming language in accordance with the actual needs. For example, the preset script may be a shell script, and may be programmed by using a SQL language, a PHP language, a Perl language, etc. Accordingly, the programmed preset script may be recognized by a Cacti system, to allow each step in the method to be implemented properly.

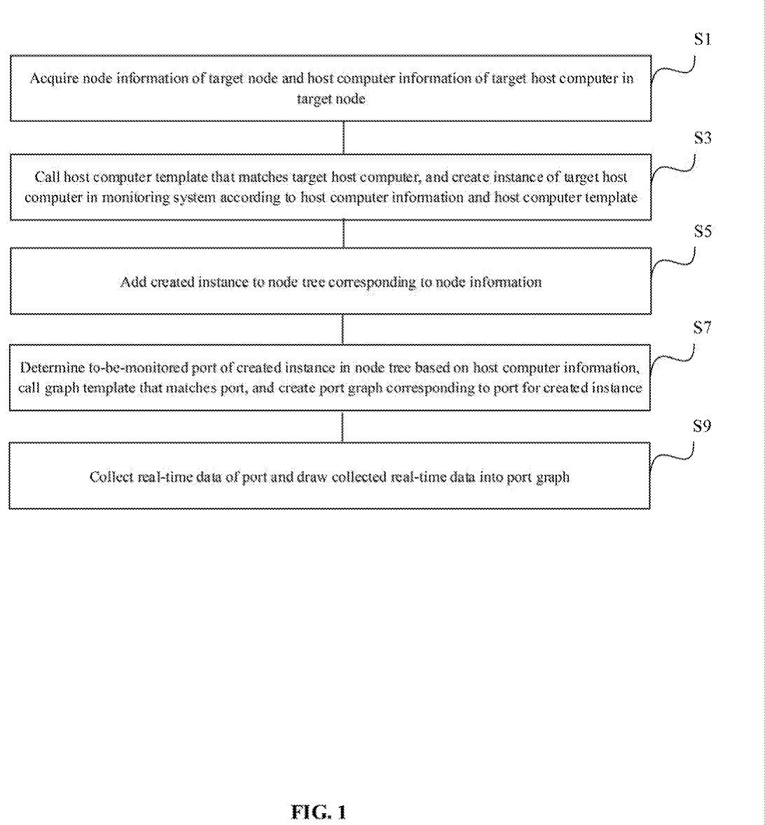

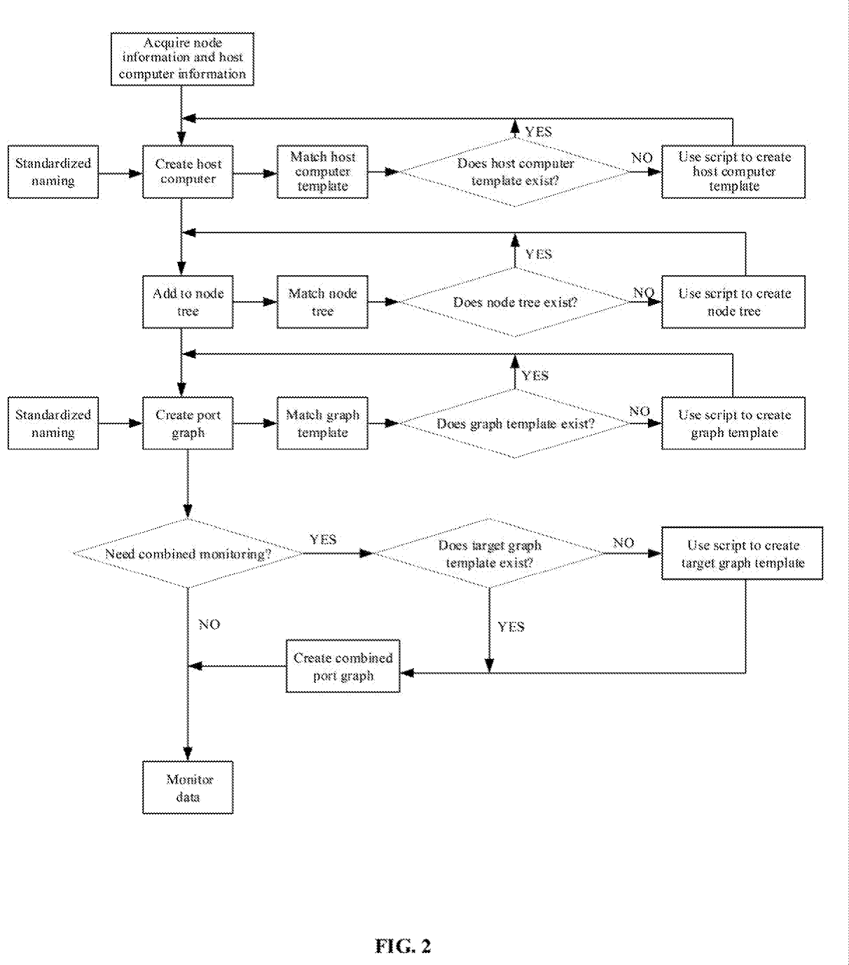

Specifically, referring to FIG. 1 and FIG. 2, a method for monitoring host computers provided by the present disclosure may include the following steps.

S1: Acquire node information of a target node and host computer information of a target host computer in the target node.

In the disclosed implementation, the target node may be a node that is to be monitored. The target node may include a plurality of host computers. In real applications, each host computer in the target node may be monitored. Apparently, according to the needs of users, there may be just some of the host computers in the target node to be monitored. A monitored host computer may be the foregoing target host computer.

In the disclosed implementation, the node information of the target node and the host computer information of the target host computer may be stored in a resource server of the CDN. In the resource server, a Cacti server in which the Cacti system resides may be added to the whitelist in advance, so that information acquisition permission may be issued to the Cacti server. In this way, by accessing the resource server, the Cacti server may acquire the corresponding node information and host computer information.

In the disclosed implementation, the node information may include information such as the name of the target node, guaranteed bandwidth, capped bandwidth, network operator, region where the node is located, and state/province where the node is located, etc. The host computer information may include information such as the IP address of the target host computer, SNMP version number, SNMP community string, SNMPV3 user name and password, SNMPV3 authentication encryption protocol, brand/model, and to-be-monitored port(s), etc. Apparently, in real applications, the node information and the host computer information may include more or less information, which is not specifically limited in the present disclosure.

S3: Call a host computer template that matches the target host computer, and create an instance of the target host computer in a monitoring system according to the host computer information and the host computer template.

In the disclosed implementation, an instance of the host computer may be created in the Cacti system by using a host computer template. The host computer template may be configured to specify which port(s) of the host computer should be monitored. The host computer template may correspond to the brand/model of the host computer. Generally, host computers with a same brand/model may have similar host computer templates. In the Cacti system, a plurality of different host computer templates may be pre-loaded. Next, when an instance of the target host computer is being created, the included brand/model may be identified from the host computer information. Based on the brand/model of the target host computer, a matching host computer template may be then identified from the pre-loaded plurality of host computer templates. After the matching host computer template is identified, the host computer template may be called and an instance of the target host computer is created in the Cacti system.

In one implementation, when creating the instance of the target host computer, it is also necessary to name the created instance. In order to make the name of the created instance to have a consistent format, in the disclosed implementation, based on the node information and the host computer information, the host computer name of the created instance may be determined according to a specified naming convention. Specifically, information such as the node name, guaranteed bandwidth, capped bandwidth, network operator, region where the node is located, and province/state where the node is located may be identified from the node information, so that a prefix like “Fujian Xiamen China Netcom [0G/140G]” may be generated. Here, “Fujian” represents the province where the target node is located, “Xiamen” represents the region where the target node is located, “China Netcom” represents the network operator corresponding to the target node, “0G” represents the guaranteed bandwidth, and “140G” represents the capped bandwidth. Next, according to the host computer information, a suffix like “hostA_IP” may be generated, where “hostA” represents the original name of the target host computer, and “IP” represents the IP address of the target host computer. Then, by combining the generated prefix and suffix together, a standardized name of the target host computer may be obtained. As can be seen, the host computer name determined for the target host computer includes at least the region information of the target node, the network operator information, the bandwidth information, and the communication address information of the target host computer.

In one implementation, for a host computer of a certain brand/model, a corresponding host computer template may not be available in the Cacti system. Under this situation, the method may further provide a script for creating a host computer template. When no host computer template matching the target host computer can be identified, the script for creating a host computer template may be called. Next, from the host computer information of the target host computer, the included model of the host computer may be identified. At the same time, the to-be-monitored port(s) of the target host computer may also be identified. Accordingly, when the script for creating a host computer template is executed in accordance with the model of the host computer, a matching host computer template may be created. In the created host computer template, which port(s) of the target host computer to be monitored may be also marked.

S5: Add the created instance to a node tree corresponding to the node information.

In the disclosed implementation, the Cacti system usually displays the monitored status of each host computer to an administrator by way of a node tree. Accordingly, after the instance of the target host computer is created, the created instance may be added to a node tree corresponding to the node information. Specifically, node trees may be classified according to different network operators and geographic locations. For example, the south region of China Telecom and south region of China Netcom may correspond to different node trees. Accordingly, the network operator and geographic location corresponding to the target host computer may be identified, and the created instance may be added to a node tree that matches the identified network operator and geographic location.

In one implementation, the node tree that corresponds to the target host computer may have not been previously created in the Cacti system. In light of this, the method may provide a script for creating a node tree. In this way, if the node tree corresponding to the node information does not exist at this moment, the network operator information and the geographical location information included in the node information may be identified. The script for creating a node tree may be then called, and executed in accordance with the node information, so that a node tree corresponding to the node information may be created. Once the node tree is created, the created instance may be then added to the node tree.

S7: Determine a to-be-monitored port(s) for the created instance in the node tree based on the host computer information, and call a graph template(s) that matches the to-be-monitored port(s), and create a port graph(s) corresponding to the to-be-monitored port(s) for the created instance.

In the disclosed implementation, after the instance of the target host computer is created and added to the corresponding node tree, based on the to-be-monitored ports of the target host computer, port graphs corresponding to the to-be-monitored ports may be created. Specifically, from the acquired host computer information, the ports of the target host computer that are to be monitored may be identified. Next, for different ports, different graph templates may be called to create corresponding port graphs. The created port graphs may include, for example, a traffic statistical graph, a packet loss rate statistical graph, a CPU usage statistical graph, a memory usage statistical graph, and the like.

In one implementation, considering that not all graph templates are preloaded in the Cacti system, a script for creating graph templates may be then provided. In this way, when there is no graph template that matches a to-be-monitored port, the port type of the port may be identified and the script for creating graph templates may be called. The called script may then be executed in accordance with the port type, to create a graph template that matches the port. Once the graph template is created, a port graph for the corresponding port may be then created.

In one implementation, in order to ensure that the created port graphs have a consistent name format, the name of each port graph may be determined according to a certain naming convention. Specifically, different naming conventions may be used for different ports. Accordingly, following a naming convention that matches the type of a current port, a graph name may be then determined for a port graph created for the current port. For example, a graph name may be expressed in terms of “host computer name+port description field+port name”. Assuming that the current port is a traffic collection port, the graph name determined for the port may be then “Fujian Xiamen China Netcom Download [0G/140G] 36.250.73.1-UPLink_WT-10GE1/0/1”, where “Fujian Xiamen China Netcom Download [0G/140G]36.250.73.1” may be the host computer name, “UPLink_WT” may be the port description field, and “10GE1/0/1” may be the port name.

S9: Collect real-time data of the port(s) and draw the collected real-time data into the port graph(s).

In the disclosed implementation, after a port graph is created for each port, the port graph may have an abscissa axis and an ordinate axis based on the format specified in the graph template. The units of the two coordinate axes may be also specified based on the graph template. When a port is in normal operation, real-time data may be generated. At this moment, the Cacti system may collect the real-time data for the port, and draw the collected real-time data into the port graph, to allow the real-time situation of the port to be directly displayed to an administrator, thereby facilitating the monitoring of the port by the administrator.

In one implementation, due to the service requirements, in certain circumstances, a plurality of ports from different host computers may need to be combined for monitoring. For example, host computer A includes port 1 to port 3, and host computer B includes port 4 and port 5. Port 1 and port 4 are both traffic ports. When a service party indicates that the traffic ports for host computer A and host computer B should be combined for monitoring, these two traffic ports will be considered as two to-be-combined ports.

In the disclosed implementation, at least two to-be-combined target ports may be determined from a plurality of to-be-monitored ports. Here, the plurality of to-be-monitored ports may belong to different host computers. After the to-be-combined target ports have been determined, it may be determined whether there currently exists a target graph template that matches the at least two to-be-combined target ports. If the target graph template exists, the template may be used to create a port graph corresponding to the at least two to-be-combined target ports. If the target graph template does not exist, the aforementioned script for creating graph templates may be called. Based on the number of ports and the port types of the at least two to-be-combined target ports, a matching target graph template may be created by using the called script. In the target graph template, the number of ports of the currently combined target ports may be marked, and the port types corresponding to the combined target ports may be also marked. In real applications, the host computers from which these target ports come may be marked as well.

Accordingly, after the corresponding port graph is created based on the target graph template, the real-time data of each of the at least two target ports may be respectively collected. The collected real-time data of the respective target ports are pooled together and drawn to the port graph created based on the target graph template, to allow combined monitoring of the multiple target ports. In addition, after creating a combined port graph, the graph name for the created port graph may be determined based on a preset naming convention. The naming convention may specify various fields to-be-included in the graph name. For example, the graph name may include a field indicating the port type(s), a field indicating the number of ports, a field indicating the names of the host computers included in the combination, etc.

In the present disclosure, the above-described preset script(s) may be executed in a specified time cycle. The specified time cycle may be, for example, one day. Accordingly, the Cacti system may start to monitor the updated nodes or host computers in the CDN at a fixed time each day. In addition, the preset script(s) may be also executed when a triggering instruction is received. The triggering instruction may be issued by an administrator in the Cacti system. If there is more than one host computer, the preset script(s) may create port graphs and monitor the data for these host computers in batch, which greatly improves the efficiency for monitoring host computers.

The present disclosure further provides a device for monitoring host computers. The device includes a system for monitoring host computers. The system is configured to implement the above-described methods for monitoring host computers.

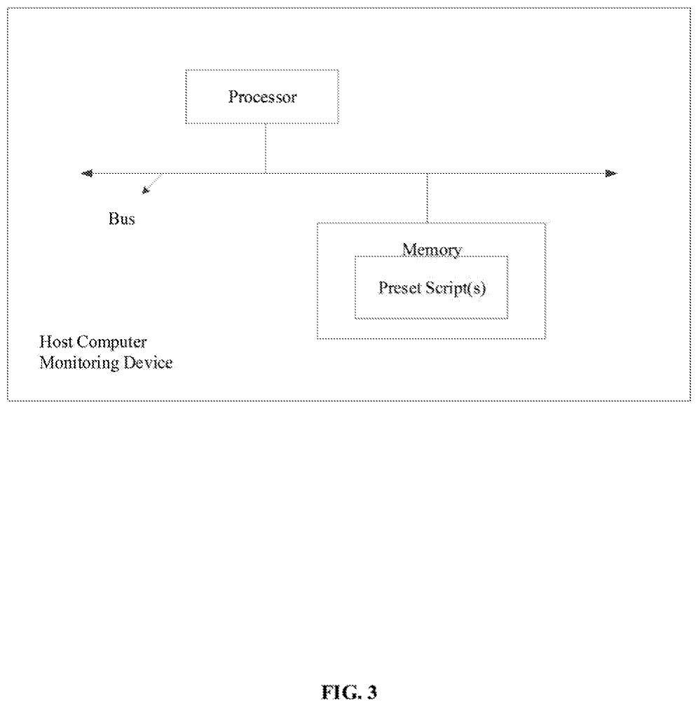

Referring to FIG. 3, the present disclosure further provides a device for monitoring host computers. The device includes a memory and a processor, where the memory is used to store a preset script(s) that, when executed by the processor, implement the above-described methods.

As can be seen from the above, in the technical solutions provided by the present disclosure, each step involved in the process of monitoring host computers may be written into a preset script. The preset script, when executed, may then implement the process of monitoring a host computer. Specifically, when the preset script is executed, the Cacti system may obtain the node information of a target node and the host computer information of a target host computer in the target node by accessing a resource server in the CDN. An instance of the target host computer may be then created through matching a template corresponding to the host computer. After the instance of the target host computer is created, the created instance may be added to a node tree corresponding to the target host computer. In order to monitor the status of each port of the target host computer by way of a graph, to-be-monitored ports for the created instance may be determined, and a port graph may be created for each port by calling a graph template that matches the port. The port graph may be configured to receive real-time data of the port, and display the collected real-time data by way of a graph, to allow an administrator to monitor the target host computer. As can be seen from the above, through an approach of pre-writing each step to the preset script, the port graphs may be created automatically and in batch for a large number of host computers, which solves the problem of inefficiency caused by human manipulation while also avoiding errors caused by human manipulation.

Through the description of the above embodiments, those skilled in the art may clearly understand that the various embodiments may be implemented by means of software plus a necessary general hardware platform, and of course, may also be implemented by hardware. Based on such understanding, the above-described technical solutions may be embodied in the form of software products in essence or in the form of software products, which may be stored in a computer-readable storage medium such as ROM/RAM, magnetic discs, optical discs, etc., and include a series of instructions for causing a computer device (which may be a personal computer, server, or network device, etc.) to perform the methods described in various embodiments or portions of the embodiments.

Although the present disclosure has been described as above with reference to preferred embodiments, these embodiments are not constructed as limiting the present disclosure. Any modifications, equivalent replacements, and improvements made without departing from the spirit and principle of the present disclosure shall fall within the scope of the protection of the present disclosure.

1. A method for monitoring host computers, comprising:
providing a preset script that, when executed, implements the following steps including:
acquiring node information of a target node and host computer information of a target host computer in the target node,
calling a host computer template that matches the target host computer, and creating an instance of the target host computer in a monitoring system according to the host computer information and the host computer template,
adding the created instance to a node tree corresponding to the node information,
determining a to-be-monitored port of the created instance in the node tree based on the host computer information, calling a graph template that matches the port, and creating a port graph corresponding to the port for the created instance, and
collecting real-time data of the port and drawing the collected real-time data into the port graph.

2. The method according to claim 1, wherein creating the instance of the target host computer further includes:
determining a host computer name for the created instance based on the node information and the host computer information by using a specified naming convention, wherein the host computer name includes at least region information of the target node, network operator information, bandwidth information, and communication address information of the target host computer.

3. The method according to claim 1, further comprising:
providing a script for creating a host computer template, wherein, if currently there is no host computer template that matches the target host computer, the method further includes:
identifying a host computer model included in the host computer information, and calling the script for creating a host computer template, and
executing the called script in accordance with the host computer model, and creating the host computer template that matches the target host computer.

4. The method according to claim 1, wherein adding the created instance to the node tree corresponding to the node information further includes:
identifying a network operator and a geographic location corresponding to the target host computer, and adding the created instance to a node tree that matches the identified network operator and geographic location.

5. The method according to claim 1, further comprising:
providing a script for creating a node tree, wherein, if currently there is no node tree corresponding to the node information, the method further includes:
calling the script for creating a node tree, executing the called script in accordance with the node information, and creating the node tree corresponding to the node information.

6. The method according to claim 1, wherein, when creating the port graph corresponding to the port for the created instance further includes:
determining a graph name for the created port graph using a naming convention that matches a type of the port.

7. The method according to claim 1, further comprising:
providing a script for creating a graph template, wherein, if currently there is no graph template that matches the port, the method further includes:
identifying a port type of the port and calling the script for creating a graph template, and
executing the called script in accordance with the port type, and creating the graph template that matches the port.

8. The method according to claim 1, wherein, after creating the port graph corresponding to the port for the created instance, the method includes:
determining at least two to-be-combined target ports from a plurality of to-be-monitored ports, and determining whether currently there is a target graph template that matches the at least two to-be-combined target ports;
if currently there is a target graph template that matches the at least two to-be-combined target ports, using the target graph template to create a port graph corresponding to the at least two to-be-combined target ports; and
if currently there is no target graph template that matches the at least two to-be-combined target ports, calling a script for creating a graph template, and using the called script to create a matching target graph template based on a number of ports and port types of the at least two to-be-combined target ports.

9. The method according to claim 8, further comprising:
respectively collecting real-time data for each of the at least two to-be-combined target ports, and pooling together the collected real-time data of each target port and drawing the pooled data into a port graph created based on the target graph template.

10. The method according to claim 1, wherein the preset script is executed according to a specified time cycle, or the preset script is executed when a triggering instruction is received.

11. A device for monitoring host computers, comprising a monitoring system for the host computer, wherein the monitoring system is configured to provide a script that, when executed, implements the following steps including:
acquiring node information of a target node and host computer information of a target host computer in the target node;
calling a host computer template that matches the target host computer, and creating an instance of the target host computer in a monitoring system according to the host computer information and the host computer template;
adding the created instance to a node tree corresponding to the node information;
determining a to-be-monitored port of the created instance in the node tree based on the host computer information, calling a graph template that matches the port, and creating a port graph corresponding to the port for the created instance; and
collecting real-time data of the port and drawing the collected real-time data into the port graph.

12. A device for monitoring host computers, comprising a memory and a processor, wherein the memory stores a preset script that, when executed by the processor, cause the device to:
acquire node information of a target node and host computer information of a target host computer in the target node;
call a host computer template that matches the target host computer, and create an instance of the target host computer in a monitoring system according to the host computer information and the host computer template;
add the created instance to a node tree corresponding to the node information,
determine a to-be-monitored port of the created instance in the node tree based on the host computer information, call a graph template that matches the port, and create a port graph corresponding to the port for the created instance, and
collect real-time data of the port and drawing the collected real-time data into the port graph.

13. The device according to claim 12, wherein the memory further stores a script for creating a host computer template, and, if currently there is no host computer template that matches the target host computer, the preset script, when executed by the processor, further causes the device to:
identify a host computer model included in the host computer information, and call the script for creating the host computer template; and
execute the called script in accordance with the host computer model, and create the host computer template that matches the target host computer.

14. The device according to claim 12, wherein the memory further stores a script for creating a node tree, and, if currently there is no node tree corresponding to the node information, the preset script, when executed by the processor, further causes the device to:
call the script for creating a node tree, execute the called script in accordance with the node information, and create the node tree corresponding to the node information.

15. The device according to claim 12, wherein the memory further stores a script for creating a graph template, and, if currently there is no graph template that matches the port, the preset script, when executed by the processor, further causes the device to:
identify a port type of the port and call the script for creating a graph template; and
execute the called script in accordance with the port type, and create a graph template that matches the port.

16. The device according to claim 12, wherein the memory further stores a script for creating a graph template, and the preset script, when executed by the processor, further causes the device to:
determine at least two to-be-combined target ports from a plurality of to-be-monitored ports, and determine whether currently there is a target graph template that matches the at least two to-be-combined target ports;
if currently there is a target graph template that matches the at least two to-be-combined target ports, use the target graph template to create a port graph corresponding to the at least two to-be-combined target ports; and
if currently there is no target graph template that matches the at least two to-be-combined target ports, call the script for creating a graph template, and use the called script to create a matching target graph template based on a number of ports and port types of the at least two to-be-combined target ports.
